(19) United States
(12) Patent Application Publication
(10) Pub. No.: US 2024/0180272 A1
(43) Pub. Date: Jun. 6, 2024

(54) GARMENT

(71) Applicant: Trade Mask Pty Ltd, Marrickville (AU)

(72) Inventors: Gavin LESTER, Phillip Bay (AU); Ann MEAGHER, Marrickville (AU)

(21) Appl. No.: 18/553,844

(22) PCT Filed: Dec. 22, 2021
(86) PCT No.: PCT/AU2021/051536

§ 371 Date: Oct. 4, 2023

(30) Foreign Application Priority Data
Dec. 22, 2020 (AU) 2020104228

(51) Int. Cl. A41D 13/11

(52) U.S. Cl. CPC A41D 13/11

(57) ABSTRACT

A garment 100 has a body portion 102 for covering the torso of a person where the body portion 102 defines a neck opening 110. A mask portion 118 extends from the body portion 102 and covers the nose and mouth of the person with fastening means 50 for securing the mask portion to the head of the person when extending through the neck opening 110. A mask neck portion 130 covers or substantially covers a front portion of the throat of the person when in use. The neck portion 130 is disposed intermediate the mask portion 118 and the body portion 102.

### FIELD

The invention relates to garments and, in particular, protective garments.

The invention has been developed primarily for use in the construction, manufacturing, retail and hospitality industries. However, it will be appreciated that the invention is not limited to these particular fields of use.

### BACKGROUND

In recent years, there has been increased awareness and concern regarding the detrimental effects of prolonged exposure of construction workers and tradespersons to airborne particulates that may arise during their work. This is particularly the case when such airborne particulates are inhaled through the nose and mouth. Some airborne particulates that may be encountered by construction workers and tradespersons for example include dust and dirt from the operation of construction equipment, exhaust from machinery and vehicles, particulate matter or smoke from nearby fires or from manufacturing facilities, and gases and fumes from toxic liquids. It will be appreciated that workers across vary many industries as well as people in domestic environments are exposed to similar hazards.

Face masks and face protection devices are well known, and have become somewhat ubiquitous with the emergence of the COVID virus. These provide coverage of the nose and mouth of the wearer to protect these areas from exposure to airborne particulates are known. Such face masks and face protection devices have the drawback of needing to be carried separately by the wearer. These can be cloth face masks, surgical masks, and partial & full face respirators.

In the case of construction workers and tradespersons, they frequently move around work sites and from site to site, and it can be cumbersome and troublesome for the construction workers and tradespersons to carry such face masks and face protection devices with them amongst other tools and equipment. It is also often the case that construction workers and tradespersons forget to carry the face masks and face protection devices with them, or purchase such face masks or face protection devices and therefore do not have one readily available during a time of need. This compounded where replacement filter members or cartridges are required.

To reduce the exposure to airborne particulates, it has become common practice for construction workers and tradespersons to simply cover their nose and mouth using the sleeve of their shirts or other parts of their shirts as an alternative to carrying and using a face mask or respirator device. However, this ad-hoc method does not provide adequate coverage of the nose and mouth and cannot be sustained for prolonged periods especially when use of hands is required to work. This therefore prevents the construction worker or tradesperson from continuing on with their work.

### Genesis of the Invention

The genesis of the invention is a desire to provide a protective garment that will overcome or substantially ameliorate one or more of the disadvantages of the prior art, or to provide a useful alternative.

### SUMMARY OF INVENTION

According to an aspect of the invention there is provided garment comprising: a body portion for covering the torso of a person, the body portion defining a neck opening; a mask portion extending from the body portion and configured to cover the nose and mouth of the person; and fastening means for securing the mask portion to the head of the person extending through the neck opening.

In preferred embodiment, the garment further includes a neck portion for covering a front portion of the neck of the person, the neck portion being disposed between the mask portion and the body portion. I

In other preferred embodiments, the mask portion has opposed first and second lateral edge portions, and wherein the fastening means comprises a pair of elastic members, each of the elastic members has a first end portion attached to a respective lateral edge portion of the mask portion and a second free end portion, the free end portions of the elastic members are configured to be releasably coupled together such that the elastic members encircle the back of the head of the person to secure the mask portion to the head of the person.

Preferably, the mask portion has opposed first and second lateral edge portions, and the fastening means includes a pair of spaced apart elastic members extending outwardly from each lateral edge such that each pair of spaced apart members are connected at respective distal ends thereof.

It can therefore be seen there is advantageously provided a garment where the mask portion is attached to the front of the collar of a garment opening which does not need to be searched for to be used and has been found to provide practical levels of protections to a user.

### BRIEF DESCRIPTION OF DRAWINGS

Preferred embodiments of the invention will now be described, by way of example only, with reference to the accompanying drawings in which:

FIG. 1 is a front view of an embodiment of a garment;

FIG. 2 is a rear view of the garment of FIG. 1;

FIG. 3 is an enlarged view of A of FIG. 1;

FIG. 4 is an enlarged view of B of FIG. 2;

FIG. 5 is a side view of the garment of FIG. 1;

FIG. 6 is a front view of the garment of FIG. 1 with mask and neck portions of the garment tucked in;

FIG. 7 is a front view of the garment of FIG. 1 with mask and neck portions of the garment hanging out;

FIG. 8 is front view of the garment of FIG. 1 being worn by a person;

FIG. 9 is a front view of another embodiment of a garment;

FIG. 10 is another front view of the garment of FIG. 9;

FIG. 11 is an enlarged view of C of FIG. 9;

FIG. 12 is a front view of the garment of FIG. 9 with a mask portion of the garment tucked in;

FIG. 13 is a front view of the garment of FIG. 9 being worn by a person; and

FIG. 14 is a front view of another preferred embodiment.

### DESCRIPTION OF EMBODIMENTS

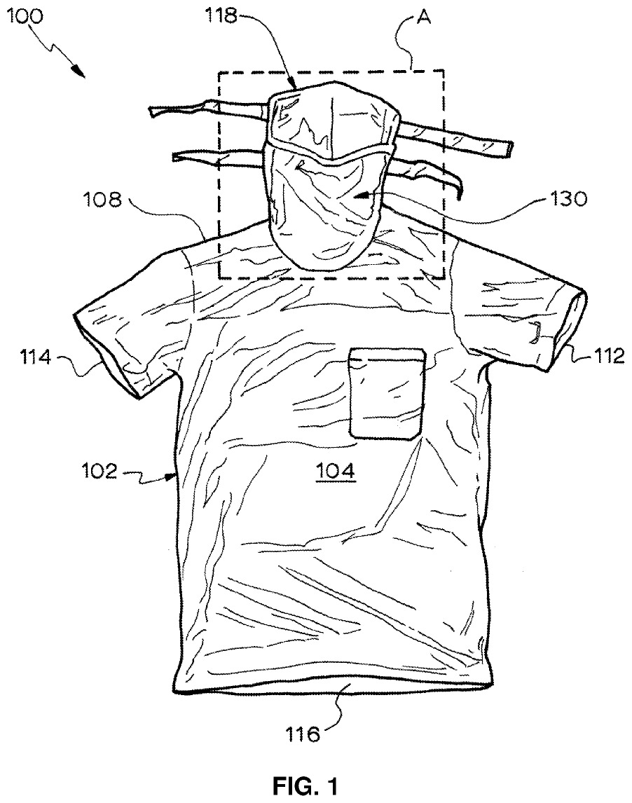

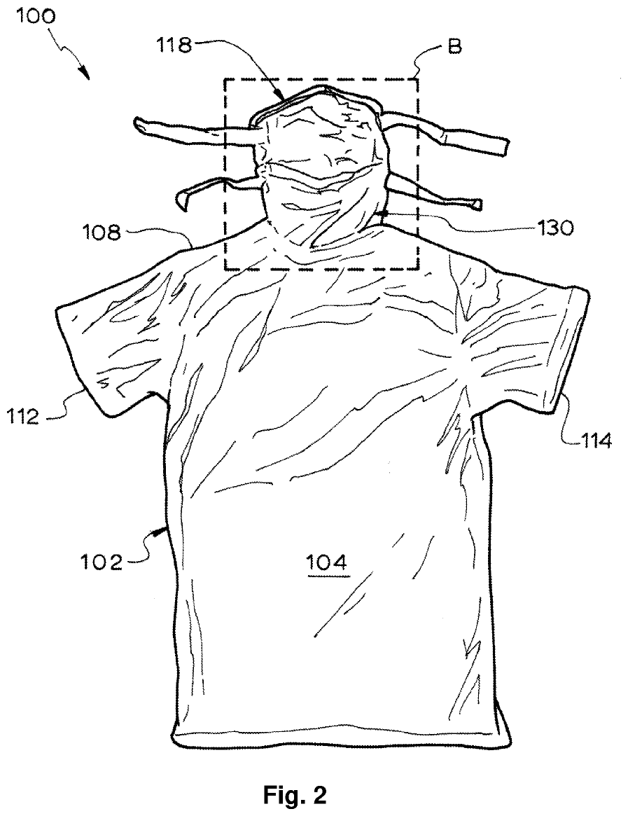

FIGS. 1 and 2 show a garment 100 according to an embodiment of the present disclosure. The garment 100 comprises a body portion 102, in the form of a T-shirt, for covering the torso of a person (hereinafter referred to as a “wearer”). The body portion 102 comprises a front panel 104 and a rear panel 106 attached to the front panel 104 along an 4 upper edge 108 so as to define a neck opening 110 through which the head and neck of the wearer can extend. The body portion 102 also defines two arm openings 112, 114 through which the arms of the wearer can extend, as well as a bottom opening 116 formed at the junction of the front and rear panels 104, 106.

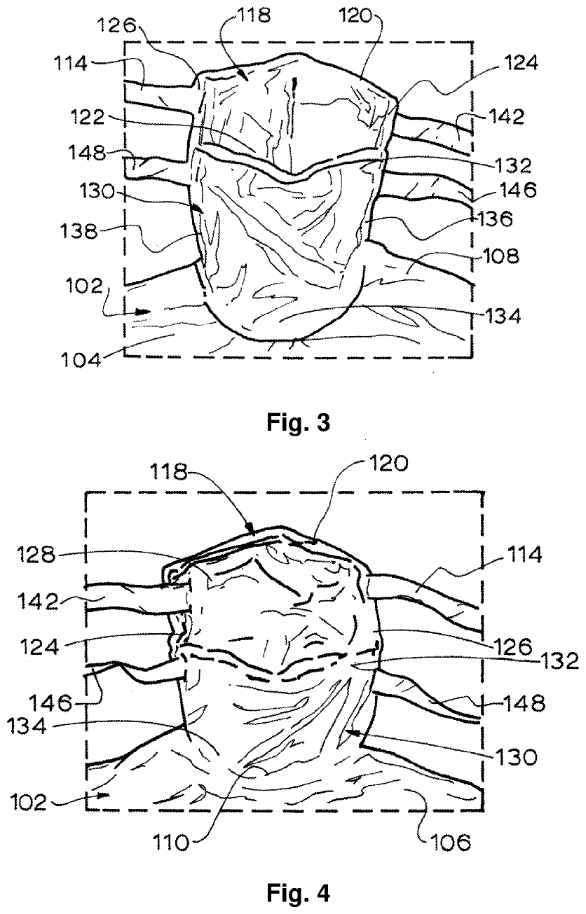

The garment 100 also comprises a mask portion 118 that extends from the body portion 102 and is configured to conform to the face of the wearer so as to cover the nose and mouth of the wearer, in use, thus providing protection thereto. With reference to FIGS. 3 and 4, the mask portion 118 comprises an upper edge portion 120, a lower edge portion 122 and opposed first and second lateral edge portions 124, 126. The mask portion 118 also comprises material formed from any fabric suitable for filtering out one or more types of airborne particles, gases and/or biological agents. The fabric may be woven or non-woven and may be formed from natural fibres, synthetic fibres or combinations thereof.

In some embodiments, the fabric may be a washable fabric. In some embodiments, the material may be composed of multiple layers of fabrics, which may be the same fabric or different types of fabric. For example, the inner and outer layers may be formed from cotton, whilst the intermediate layers between the inner and outer layers may be formed from polyester, activated carbon fabric or combinations thereof. The different layers may be selected to provide the desired filtering characteristics. The choice of material can be selected depending on the environment in which the garment 100 is to be used. For example, material with a lower atmospheric particulate matter rating can be used by firefighters or healthcare workers to reduce the exposure to fine particles in air or smoke compared to material with a higher atmosphere particulate matter rating can be used by construction workers or tradespersons to reduce the exposure to larger dust particles. Preferably, the material allows for airflow therethrough, making it breathable, but also retards or prevents one or more types of airborne particles, gasses and/or biological agents.

The mask portion 118 also comprises a pocket 128 disposed between the first and second lateral edge portions 124, 126, as shown in FIG. 4. The pocket 128 is configured to receive one or more replaceable filter elements (not shown) therein. The filter element can comprise material suitable for filtering out one or more types of airborne particles, gases and/or biological agents, for example, a PM2.5 or higher filter material (e.g., N95, N99, N100, P100 etc.).

The mask portion 118 also comprises an elongate malleable member (not shown) disposed in the upper edge portion 120. The malleable member is provided so that the upper edge portion 120 can be adjusted to closely fit the contours of the nose and upper cheeks of the wearer. The malleable member may be formed from a deformable metallic or plastic strip, or any other suitable malleable material.

The garment 100 further comprises a neck portion 130 which is configured to cover a front portion of the neck of the wearer, in use, thus providing protection thereto. The neck portion 130 comprises an upper edge portion 132, a lower edge portion 134 and opposed first and second lateral edge portions 136, 138. With reference to FIGS. 3 to 5, the lower edge portion 134 is attached, by stitching, to the front panel 104 of the body portion 102 at or adjacent the neck opening 110, and the upper edge portion 132 is attached, by stitching, to the lower edge portion 122 of the mask portion 118 such that the neck portion 130 is disposed between the mask portion 118 and the body portion 102. The neck portion 130 may comprise material that is the same or similar to that of the mask portion 118.

In other embodiments, the neck portion 130 may be attached to the mask portion 118 and releasably attachable to the garment opening 130 at a front portion.

The garment 100 further comprises fastening means for securing the mask portion 118 to the head of the wearer. In this embodiment, the fastening means comprises a first pair of elastic members 142, 144 having first end portions 142a, 144a that are attached, by stitching, to respective lateral edge portions 124, 126 of the mask portion 118 at or adjacent the upper edge portion 120, and second free end portions 142b, 144b. The fastening means also comprises a second pair of elastic members 146, 148 for securing the neck portion 130 to the neck of the wearer. The second pair of elastic members 146, 148 have first end portions 146a, 148a that are attached, by stitching, to respective lateral edge portions 136, 138 of the neck portion 130 at or adjacent the upper edge portion 132, and second free end portions 146b, 148b.

Buttons 150 and corresponding buttonholes 152 are provided on the free end portions 142b, 146b and the free end portions 144b, 148b, respectively, so as to allow the first pair of elastic members 142, 144 to be releasably coupled together, in use, and the second pair of elastic members 145, 148 to be releasably coupled together, in use. It will be appreciated that 6 the first and second pair of elastic members 142, 144, 146, 148 may be releasably coupled together using any other suitable mechanisms, such as hook and loop fasteners, snap fasteners, Velcro®, buckles, for example. Similarly, releasably engageable hooks can be disposed at the end of the elastic members.

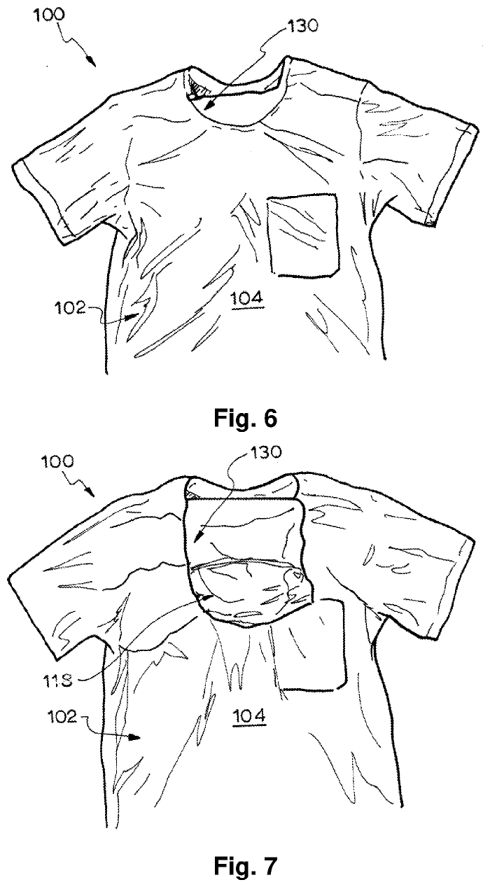

In a manner of use, the garment 100 is donned by the wearer in a similar manner as one would wear a conventional T-shirt. The mask portion 118 and neck portion 130 may initially be tucked rearwardly under the front panel 104 of the body portion 102, as shown in FIG. 6. Alternatively, the mask portion 118 and the neck portion 130 may initially rest forwardly over the front panel 104 of the body portion 102, as shown in FIG. 7. The mask portion 118 may be deployed by grasping the first pair of elastic members 142, 144, moving the mask portion 118 upwards such that the mask portion 118 covers the nose and mouth of the wearer and the neck portion 130 covers a front portion of the neck of the wearer, and coupling the first pair of elastic members 142, 144 together at or near the back of the head of the wearer by fastening the button 150 to a corresponding buttonhole 152.

When coupled, the first pair of elastic members 142, 144 encircle the back of the head of the wearer so as to secure the mask portion 118 to the head of the person. The wearer may select an appropriate buttonhole 152 to ensure a firm, yet comfortable, fit of the mask portion 118 to the head of the wearer. It will be appreciated that the edges 138 and/or 126 and 136 and/or 124 can be formed from elastic to extend to the opening.

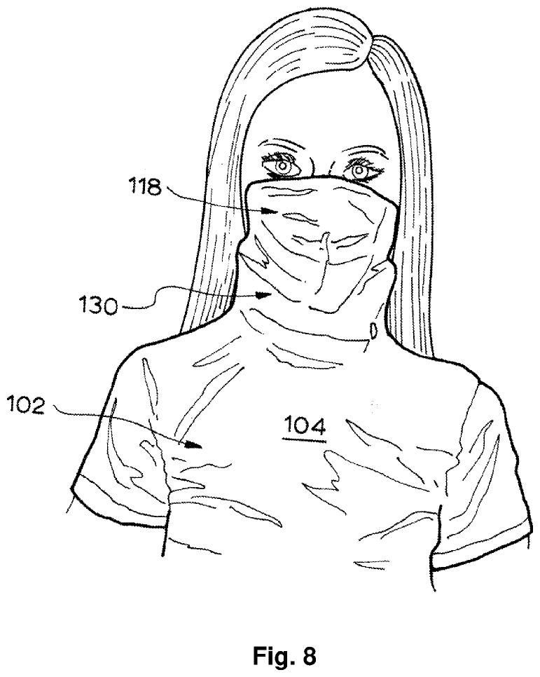

Preferably, the first pair of elastic members 144, 146 are positioned above the ears of the wearer to retain the mask portion 118 in position and to ensure a firm fit of the mask portion 118 to the head of the wearer. The upper edge portion 120 of the mask portion 118 is positioned across the nose and below the eyes of the wearer so as to not impede vision and adjusted, by way of pressing on the malleable member, to closely fit the contours of the nose and upper cheeks of the wearer. The second pair of elastic members 146, 148 may then be coupled together at or near the back of the neck of the wearer by fastening the button 150 to a corresponding buttonhole 152. When coupled, the second pair of elastic members 146, 148 encircle the back of the neck of the wearer so as to secure the neck portion 130 to the neck of the wearer. The wearer may select an appropriate buttonhole 152 to ensure a firm, yet comfortable, fit of the neck portion 130 to the neck of the wearer. Once fitted, the mask portion 118 and the neck portion 130 provide coverage to the nose, mouth and neck of the wearer, as shown in FIG. 8.

The mask portion 118 and the neck portion 130 are configured to only partially cover the face and the neck of the wearer, thus allowing free air circulation towards other uncovered areas of the face and neck of the wearer.

When coverage is no longer required, the wearer may then release the first and second pair of elastic members 142, 144, 146, 148, which releases the mask portion 118 from the face of the wearer and the neck portion 130 from the neck of the wearer, such that the mask portion 118 and the neck portion 130 fall forwardly over the front panel 104 of the body portion 102 and is held there via attachment of the neck portion 130 to the body portion 102. The wearer may also subsequently tuck the mask portion 118 and the neck portion 130 rearwardly under the front panel 104 of the body portion 102.

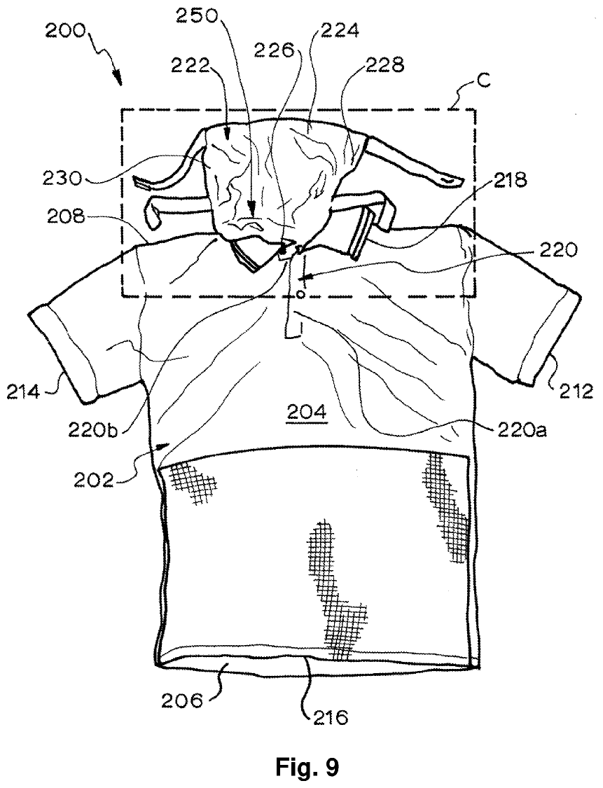

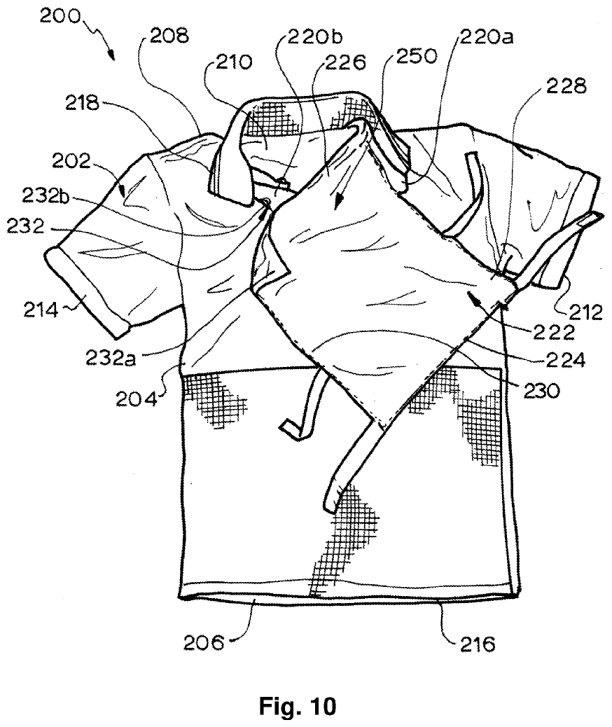

FIGS. 9 and 10 show a garment 200 according to another embodiment of the present disclosure. The garment 200 comprises a body portion 202, in the form of a polo T-shirt, for covering the torso of a wearer. The body portion 202 comprises a front panel 204 and a rear panel 206 attached to the front panel 204 along an upper edge 208 so as to define a neck opening 210 through which the head and neck of the wearer can extend. The body portion 202 also defines two arm openings 212, 214 through which the arms of the wearer can extend, as well as a bottom opening 216 formed at the junction of the front and rear panels 204, 206. Further, the body portion 202 comprises a collar 218 and a front placket 220 having first and second placket edge portions 220a, 220b.

The garment 200 also comprises a mask portion 222 and a neck portion 250 which, in this embodiment, are integrally formed as a unitary piece that extends from the body portion 204. The mask portion 222 is configured to cover the nose and mouth of the wearer, in use, thus provide protection thereto, and the neck portion 250 is configured to cover a front portion of the neck of the wearer, in use, thus providing protection thereto. The mask portion 222 and neck portion 250 together comprise an upper edge portion 224, a lower edge portion 226 and opposed first and second lateral edge portions 228, 230.

As shown in FIG. 10, a portion of the first lateral edge portion 228 which is adjacent the lower edge portion 226 is attached, by stitching, to the front panel 204 of the body portion 202 between the first placket portion 220a and the upper edge 208. A snap fastener 232 is also provided. The snap fastener 232 comprises a male part 232a disposed on the neck portion 250 at the intersection of the lower edge portion 226 and the second lateral edge portion 230, and a female part 232b disposed on the second placket edge portion 220b of the body portion 202 at or adjacent the neck opening 210.

As noted, snap fasteners can be replaced with any preferred fastening mechanism as desired.

The mask portion 222 and the neck portion 250 comprise material formed from any fabric suitable for filtering out one or more types of airborne particles, gases and/or biological agents. The fabric may be woven or non-woven and may be formed from natural fibres, synthetic fibres or combinations thereof. In some embodiments, the fabric may be a washable fabric. In some embodiments, the material may be composed of multiple layers of fabrics, which may be the same fabric or different types of fabric. The different layers may be selected to provide the desired filtering characteristics. The choice of material can be selected depending on the environment in which the garment 200 is to be used. Preferably, the material allows for airflow therethrough, making it breathable, but also retards or prevents one or more types of airborne particles, gasses and/or biological agents.

In some embodiments, the mask portion 222 may also comprise a pocket for receiving one or more replaceable filter elements therein. The filter element can comprise material suitable for filtering out one or more types of airborne particles, gases and/or biological agents, for example, a PM2.5 or higher filter material (e.g., N95, N99, N100, P100 etc.).

In some embodiments, the mask portion 222 may further comprise an elongate malleable member disposed in the upper edge portion 224 so that the upper edge portion 224 can be adjusted to closely fit the contours of the nose and upper cheeks of the wearer. The malleable member may be formed from a metallic strip or any other suitable malleable material.

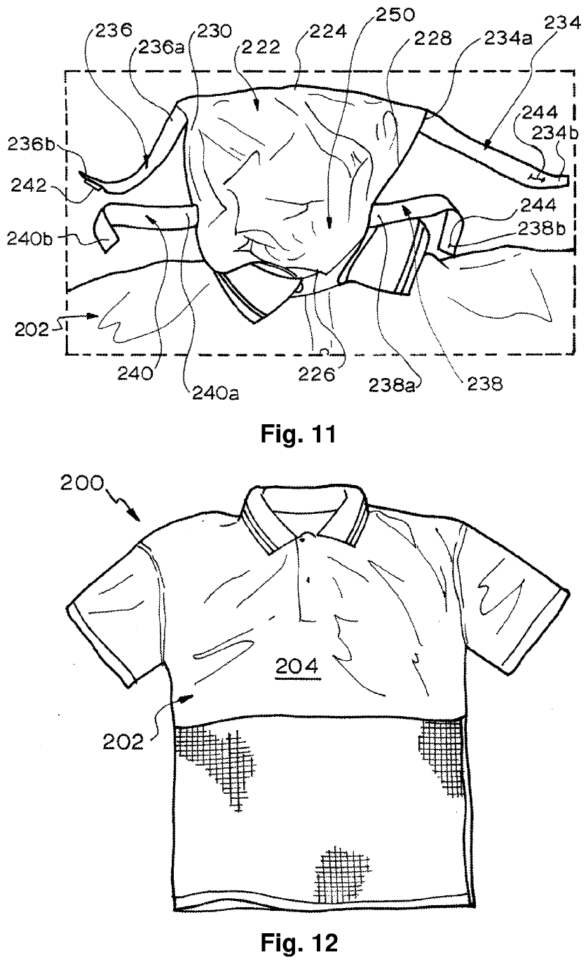

The garment 200 also comprises fastening means for securing the mask portion 222 to the head and neck of the wearer. In this embodiment, as best shown in FIG. 11, the fastening means comprises a first pair of elastic members 234, 236 having first end portions 234a, 236a that are attached, by stitching, to the mask portion 222 at respective lateral edge portions 228, 230 at or adjacent the upper edge portion 224, and second free end portions 234b, 236b. The fastening means also comprises a second pair of elastic members 238, 240 for securing the neck portion 250 to the neck of the wearer. The second pair of elastic members 238, 240 have first end portions 238a, 240a that are attached, by stitching, to the neck portion 250 at respective lateral edge portions 228, 230, and second free end portions 238b,240b. 9

Buttons 242 and corresponding buttonholes 244 are provided on the free end portions 236b, 240b and the free end portions 234b, 238b, respectively, so as to allow the first pair of elastic members 234, 236 to be releasably coupled together, in use, and the second pair of elastic members 238, 240 to be releasably coupled together, in use. It will be appreciated that the first and second pair of elastic members 234, 236, 238, 240 may be releasably coupled together using any other suitable mechanisms, such as hook and loop fasteners, snap fasteners, Velcro®, buckles, for example.

In a manner of use, the garment 200 is donned by the wearer in a similar manner as one would wear a conventional polo T-shirt. The mask portion 222 and the neck portion 250 may initially be tucked rearwardly under the front panel 204 of the body portion 202 so as to be hidden from view, as shown in FIG. 12. The mask portion 222 may be deployed by fastening the male and female parts 232a, 232b of the snap fastener 232 together, moving the mask portion 222 upwards such that the mask portion 222 covers the nose, the mouth and a front portion of the neck of the wearer, and coupling the first pair of elastic members 234, 236 together at or near the back of the head of the wearer by fastening the button 242 to a corresponding buttonhole 244. When coupled, the first pair of elastic members 234, 236 encircle the back of the head of the wearer so as to secure the mask portion 222 to the head of the person.

The wearer may select an appropriate buttonhole 244 to ensure a firm, yet comfortable, fit of the mask portion 222 to the head of the wearer. Preferably, the first pair of elastic members 234, 236 are positioned above the ears of the wearer to retain the mask portion 222 in position and to ensure a firm fit of the mask portion 222 to the head of the wearer. The upper edge portion 224 of the mask portion 222 is positioned across the nose and below the eyes so as to not impede vision. The second pair of elastic members 238, 240 may then be coupled together at or near the back of the neck of the wearer by fastening the button 242 to a corresponding buttonhole 244. When coupled, the second pair of elastic members 238, 240 encircle the back of the neck of the wearer so as to secure the neck portion 250 to the neck of the wearer. The

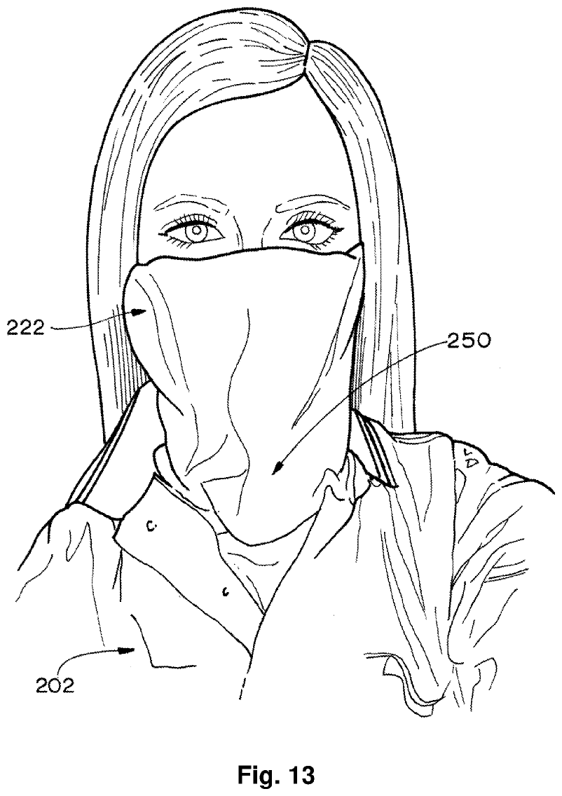

AH25(31153927_1):SDG wearer may select an appropriate buttonhole 244 to ensure a firm, yet comfortable, fit of the neck portion 250 to the neck of the wearer. Once fitted, the mask portion 222 and the neck portion 250 provide coverage to the nose, mouth and neck of the wearer, as shown in FIG. 13.

The mask portion 222 and the neck portion 250 are configured to only partially cover the face and the neck of the wearer, thus allowing free air circulation towards other uncovered areas of the face and neck of the wearer.

When coverage is no longer required, the wearer may then release the first and second pair of elastic members 234, 236, 238, 240, which releases the mask portion 222 from the face of the wearer and the neck portion 250 from the neck of the wearer, such that the mask portion 222 and the neck portion 250 fall forwardly over the front panel 204 of the body portion 202 and are held there via their attachment to the body portion 202. The wearer may also subsequently tuck the mask portion 222 and the neck portion 250 rearwardly under the front panel 204 of the body portion 202. In alternative embodiments, the fastening means may comprise one pair of elastic members only. In further alternative embodiments, the fastening means may comprise three or more pairs of elastic members.

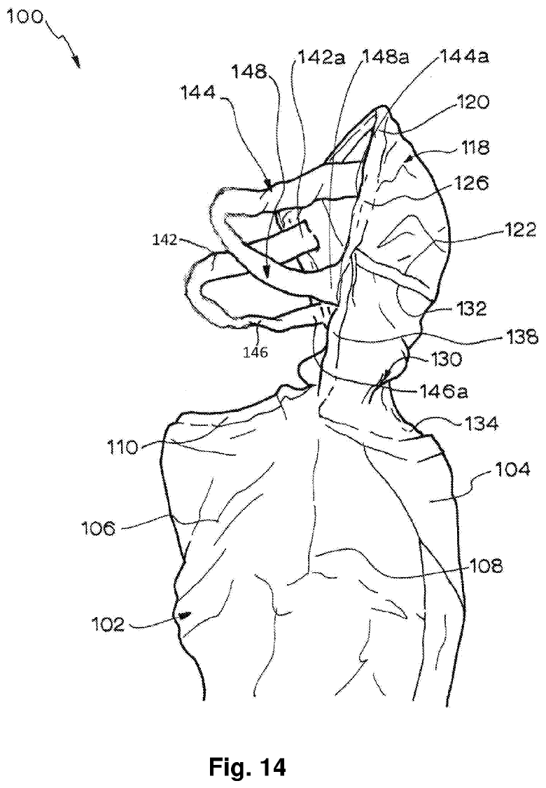

In other embodiments, such as shown in FIG. 14 and described below, the fastening means may comprise a pair of ear loops which are configured to be slipped around the ears of the wearer, in use. The ear loops may be attached, by stitching, for example, to the mask portion or may be formed integrally with the mask portion.

In the above embodiments, the mask portions 118, 222 have been described as being secured to the head of the wearer. There may be instances however where a wearer, such as a construction worker or tradesperson, may also be required to additionally wear protective headwear (e.g., a hardhat) when on a work site. Accordingly, it will be appreciated that the mask portions 118, 222 of the above described embodiments may instead be secured to the protective headwear worn by the wearer, rather than to the head of the wearer. In this regard, the first pair of elastic members 142, 144 of the garment 100 may be coupled together, in use, at or near the back of the head of the wearer such that the first pair of elastic members 142, 144 encircle the back of the headwear to secure the mask portion 118 thereto. Similarly, the first pair of elastic members 234, 236 of the garment 200 may be coupled together, in use, at or near the back of the head of the wearer such that the first pair of elastic members 234, 236 encircle the back of the headwear to secure the mask portion 222 thereto.

It will be appreciated that in other embodiments the body portion of the garment may be in any form of shirt or upper body garment including long-sleeve shirts, sweaters, jackets and coats, for example.

Advantageously, the garments 100, 200 have the appearance of a conventional shirt, yet incorporates a convenient, easy-to-use, and readily accessible protective mask for covering the nose and mouth which is ready for use during a time of need. The garments 100, 200 are also easy to manufacture and can be utilised in various environmental conditions and is suited for use on work environments from construction to hospitality to landscaping, retail, recreational and domestic use. It will be appreciated the mask can not only provide some protection against environmental pollutants and particles, it can also function to prevent spreading of droplets or the like from a users oral or nasal cavities.

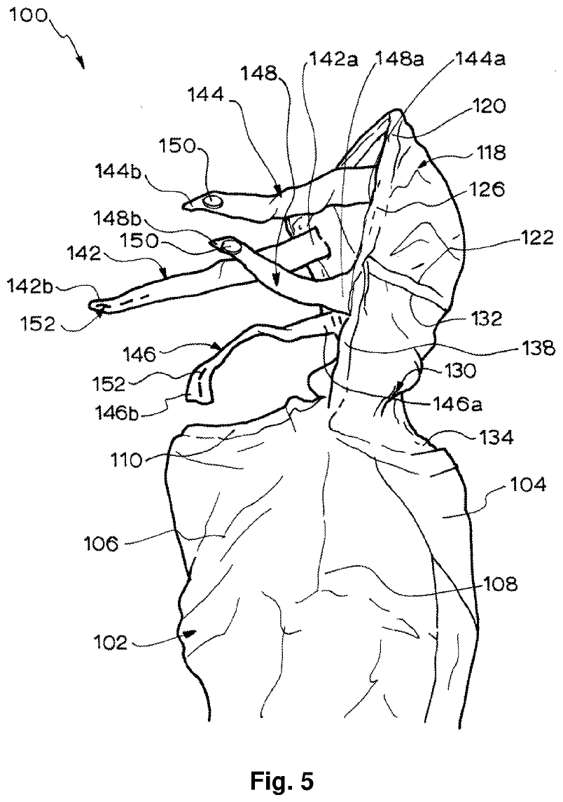

In respect of FIG. 14, there is shown another preferred embodiment of the garment 100. This embodiment is similar to that shown in FIG. 5 except elastic members 142 and 146 are integrally formed and are configured to attach about the rear of the ears of a user. That is, elastic members 142 & 146 form a loop. Likewise with elastic members 144 and 148 which are connected at their ends to form a loop to be retained about the rear of an ear.

In preferred embodiments, the lower end of the neck portion 134 fixed to the opening 110 or can be releasably connectable to the opening 100. It will be appreciated that lower end 134 can be fixed or connectable along its length to opening 110 or it can be attached or attachable to the opening at opposing ends of lower end 134 to corresponding spaced apart portions on the neck 110 least opposing lower end lateral portions of the neck. Further, the lower end 134 of the neck 130 can be connectable or fixed along some predetermined length along the opening 110 intermediate the lower end lateral portions.

In some preferred embodiments, the neck portion 130 lateral edges include seams or reinforcing members extending intermediate the opening and mask portion lateral edges. Further, the garment 100 of the preferred embodiment can be in the form of a buttoned shirt, a polo or T-shirt, a jacket, sweater/jumper; gown; smock; singlet; or other upper torso covering having a neck opening. It will be appreciated that the opening 110 can be hemmed or collared, and the mask portion 118 is fixed or releasably attached to part of the opening 110.

The foregoing describes only one embodiment of the present invention and modifications, obvious to those skilled in the art, can be made thereto without departing from the scope of the present invention.

The term “comprising” (and its grammatical variations) as used herein is used in the inclusive sense of “including” or “having” and not in the exclusive sense of “consisting only of”

1. A garment comprising: a body portion for covering the torso of a person, the body portion defining a neck opening; a mask portion extending from the body portion and configured to cover the nose and mouth of the person; and fastening means for securing the mask portion to the head of the person extending through the neck opening.

2. The garment of claim 1, further comprising a neck portion for covering a front portion of the neck of the person, the neck portion being disposed between the mask portion and the body portion.

3. The garment of claim 1 or 2, wherein the mask portion has opposed first and second lateral edge portions, and wherein the fastening means comprises a pair of elastic members, each of the elastic members has a first end portion attached to a respective lateral edge portion of the mask portion and a second free end portion, the free end portions of the elastic members are configured to be releasably coupled together such that the elastic members encircle the back of the head of the person to secure the mask portion to the head of the person.

4. The garment of claim 3, wherein the free end portions of the elastic members are releasably coupled together by way of a button and a buttonhole; corresponding hook and loop fasteners; stud fasteners; or by clips.

5. The garment of claim 2, wherein the mask portion and the neck portion are integrally formed.

6. The garment of claim 1 or 2 wherein the mask portion has opposed first and second lateral edge portions, and the fastening means includes a pair of spaced apart elastic members extending outwardly from each lateral edge such that each pair of spaced apart members are connected at respective distal ends thereof.

7. The garment of claim 2 wherein a lower end of the neck portion is fixed or releasably connectable to a portion of the opening.

8. The garment of claim 7 wherein the lower end of the neck portion is attached to the opening at at least opposing lower end lateral portions of the neck.

9. The garment of claim 7 wherein the lower end of the neck portion extends a predetermined length along the opening intermediate the lower end lateral portions.

10. The garment of claim 1 in the form of a buttoned shirt, a polo or T-shirt, a jacket, sweater/jumper; gown; smock; singlet; or other upper torso covering having a neck opening.

11. The garment of claim 6 Wherein the neck portion lateral edges include seams or reinforcing members extending intermediate the opening and mask portion lateral edges.

12. The garment of claim 1 wherein the opening is hemmed or collared, and the mask portion is fixed or releasably attached to part of the opening.
